(19) United States
(12) Patent Application Publication
(10) Pub. No.: US 2026/0302466 A1
(43) Pub. Date: Oct. 1, 2026

(54) BATTERY CHARGER

(71) Applicant: MILWAUKEE ELECTRIC TOOL CORPORATION, Brookfield, WI (US)

(72) Inventors: Joseph S. Wilinski, Wauwatosa, WI (US); Christopher S. Spaulding, Green Bay, WI (US); Van N. Heyer, Milwaukee, WI (US); Danielle A. Newman, Menomonee Falls, WI (US); Ellen M. Owens, Wauwatosa, WI (US); Colin J. Roberts, Brookfield, WI (US); Megan L. Korbel, Wauwatosa, WI (US)

(21) Appl. No.: 19/635,227

(22) Filed: Mar. 31, 2026

Related U.S. Application Data
(60) Provisional application No. 63/781,260, filed on Mar. 31, 2025.

(51) Int. Cl. H01M 50/233; H01M 10/613; H01M 10/6563; H01M 50/244; H01M 50/269; H01M 50/271; H01M 50/284; H02J 7/00; H02J 7/70; H02J 50/00

(52) U.S. Cl. CPC H01M 50/233; H01M 10/613; H01M 10/6563; H01M 50/244; H01M 50/269; H01M 50/271; H01M 50/284; H02J 7/751; H02J 7/865; H02J 50/005; H02J 2207/30

(57) ABSTRACT

A battery charger includes a housing having a base and a lid pivotally coupled to the base, the base and the lid cooperating to define a compartment when the lid is in a closed position, a battery receptacle coupled to the housing and configured to receive a battery, and a bi-directional power port. The battery charger is operable in a first mode in which the bi-directional power port is electrically coupled to an external power source and a second mode in which the bi-directional power port is electrically coupled to an electronic device. The battery charger is configured to charge the battery in the first mode, and the battery charger is configured to provide power from the battery to the electronic device in the second mode.

### CROSS-REFERENCE TO RELATED APPLICATIONS

This application claims priority to U.S. Provisional Patent Application No. 63/781,260, filed on Mar. 31, 2025, the entire contents of which are incorporated herein by reference.

### FIELD

The present disclosure relates to battery chargers and, more specifically, to portable battery chargers adapted to receive power tool battery packs.

### BACKGROUND

Previous approaches to battery chargers have typically focused on providing a single function, such as charging a battery or powering an electronic device. For example, traditional battery chargers have been designed to charge a battery from an external power source, but have not been capable of providing power from the battery to an electronic device. While some power banks have been designed to provide power from a battery to an electronic device while also charging the battery, such power banks may not be suitable for rugged, job-site conditions typically encountered by users of power tools. In addition, such power banks do not provide protection for the battery or the connected electronic devices.

### SUMMARY

Accordingly, a need exists for a durable, portable, multi-function charger.

In some aspects, the techniques described herein relate to a battery charger including: a housing including a base and a lid pivotally coupled to the base, the base and the lid cooperating to define a compartment when the lid is in a closed position; a battery receptacle coupled to the housing and configured to receive a battery; and a bi-directional power port, wherein the battery charger is operable in a first mode in which the bi-directional power port is electrically coupled to an external power source and a second mode in which the bi-directional power port is electrically coupled to an electronic device, wherein the battery charger is configured to charge the battery in the first mode, and wherein the battery charger is configured to provide power from the battery to the electronic device in the second mode.

In some aspects, the techniques described herein relate to a battery charger, further including a wireless charging pad coupled to the housing.

In some aspects, the techniques described herein relate to a battery charger, wherein the wireless charging pad is located on the lid.

In some aspects, the techniques described herein relate to a battery charger, wherein the battery charger is operable in a third mode in which the electronic device is positioned proximate the wireless charging pad, and wherein the battery charger is configured to provide power from the battery to the electronic device via the wireless charging pad in the third mode.

In some aspects, the techniques described herein relate to a battery charger, wherein the battery receptacle is located inside the compartment.

In some aspects, the techniques described herein relate to a battery charger, wherein the battery is configured to be coupled to and removed from the battery receptacle along a battery insertion axis, and wherein the battery receptacle is rotatable to vary an orientation of the battery insertion axis relative to the housing.

In some aspects, the techniques described herein relate to a battery charger, wherein the housing includes an electronics housing coupled to the base, the electronics housing enclosing a PCBA electrically coupled to the battery receptacle and the bi-directional power port.

In some aspects, the techniques described herein relate to a battery charger, wherein the battery receptacle includes a terminal mount rotatably coupled to the electronics housing.

In some aspects, the techniques described herein relate to a battery charger, wherein the electronics housing includes a circular aperture, and wherein the terminal mount includes an annular boss received in the circular aperture.

In some aspects, the techniques described herein relate to a battery charger, wherein the bi-directional power port is a first power port, and wherein the battery charger further includes a second power port located inside the compartment.

In some aspects, the techniques described herein relate to a battery charger, wherein the first power port is located outside the compartment such that the first power port is accessible from an exterior of the housing.

In some aspects, the techniques described herein relate to a battery charger, wherein the lid includes a plurality of recesses, and the base includes a plurality of cleats.

In some aspects, the techniques described herein relate to a battery charger, wherein the first power port is a USB-C port.

In some aspects, the techniques described herein relate to a battery charger including: a housing including a base and a lid pivotally coupled to the base, the base and the lid cooperating to define a compartment configured to receive and store an electronic device when the lid is in a closed position; a battery receptacle coupled to the housing inside the compartment and configured to receive a battery such that the battery is positionable inside the compartment; a power port located inside the compartment, the power port configured to be electrically coupled to an electronic device to provide power from the battery to the electronic device while the electronic device is located within the compartment.

In some aspects, the techniques described herein relate to a battery charger, wherein the base includes a plurality of cleats and the lid includes a plurality of recesses such that the battery charger is configured to be coupled to a modular tool storage system without the use of tools.

In some aspects, the techniques described herein relate to a battery charger, wherein the housing includes an electronics housing coupled to the base, the electronics housing enclosing a PCBA electrically coupled to the battery receptacle and the power port.

In some aspects, the techniques described herein relate to a battery charger, further including a fan within the electronics housing to cool the PCBA.

In some aspects, the techniques described herein relate to a battery charger, wherein the battery receptacle is rotatably coupled to the electronics housing.

In some aspects, the techniques described herein relate to a battery charger, further including a wireless charging pad located on the lid.

In some aspects, the techniques described herein relate to a battery charger including: a housing including a base and a lid, the base and the lid cooperating to define a compartment within the housing, the base including a plurality of cleats and the lid including a plurality of recesses; a battery receptacle coupled to the housing inside the compartment and configured to receive a battery such that the battery is positionable inside the compartment; a bi-directional power port configured to connect to an external power source to provide power to the battery and configured to connect to an electronic device to provide power from the battery to the electronic device.

Other aspects of the disclosure will become apparent by consideration of the detailed description and accompanying drawings.

### BRIEF DESCRIPTION OF THE DRAWINGS

FIG. 1A is a top perspective view of a battery charger according to an embodiment of the present disclosure.

FIG. 1B is a bottom perspective view of the battery charger of FIG. 1A.

FIG. 1C is a top perspective view of the battery charger of FIG. 1A with a lid of the battery charger in an open position.

FIG. 1D is a partially exploded perspective view of an electronics housing and terminal of the battery charger of FIG. 1A.

FIG. 1E is a cross-sectional view taken along line 1E—1E in FIG. 1D.

FIG. 1F is a cross-sectional view taken along line 1F—1F in FIG. 1A.

FIG. 1G is a schematic illustration of a first embodiment of an electrical connection to a wireless charger of the battery charger of FIG. 1A.

FIG. 1H is a schematic illustration of a second embodiment of an electrical connection to the wireless charger of the battery charger of FIG. 1A.

FIG. 2A is a perspective view of a battery charger according to another embodiment of the present disclosure, in an open position.

FIG. 2B is a perspective view of the battery charger of FIG. 2A in a closed position.

FIG. 3 is a perspective view of the battery charger of FIG. 2A with secondary batteries received in a compartment of the battery charger.

FIG. 4A is a perspective view of a battery charger according to another embodiment of the present disclosure.

FIG. 4B is a perspective view of a modular tool storage system including brackets to which the battery charger of FIG. 4A may be mounted.

FIG. 4C is a perspective view of the battery charger of FIG. 4A mounted to the modular tool storage system of FIG. 4B.

FIG. 5A is a perspective view of a battery charger according to another embodiment of the present disclosure.

FIG. 5B is a perspective view of the battery charger of FIG. 5A mounted to a wall mount.

FIG. 6A is a perspective view of a battery charger according to another embodiment of the present disclosure.

FIG. 6B is a perspective view of the battery charger of FIG. 6A positioned in a vehicle cupholder.

FIG. 6C is a perspective view of the battery charger of FIG. 6A coupled to a modular tool storage system.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

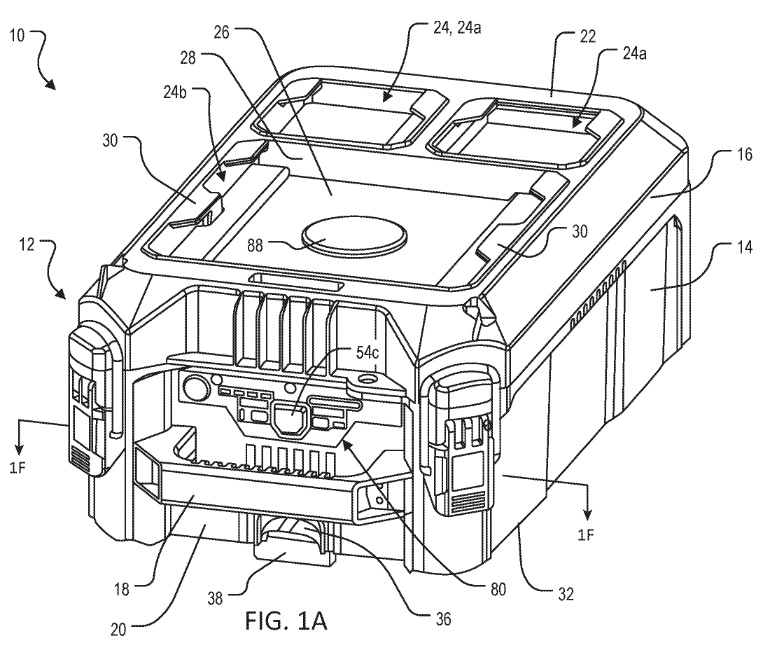

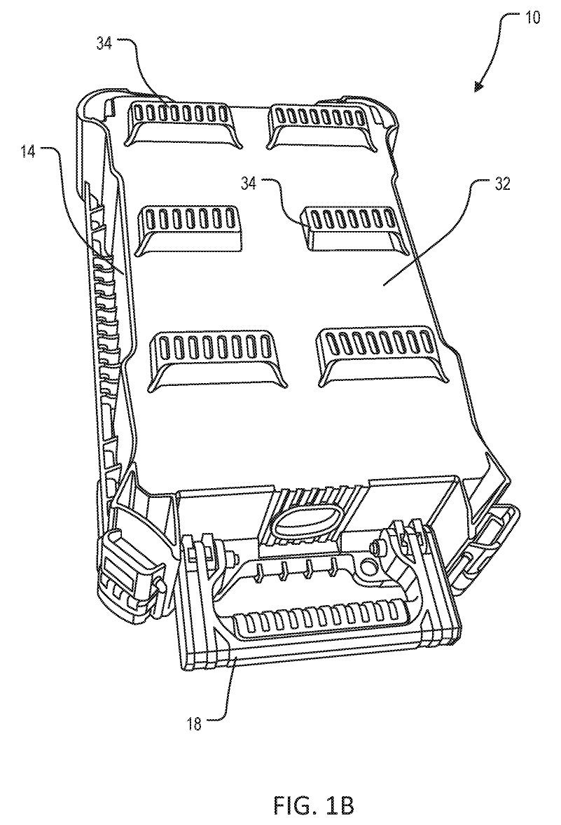

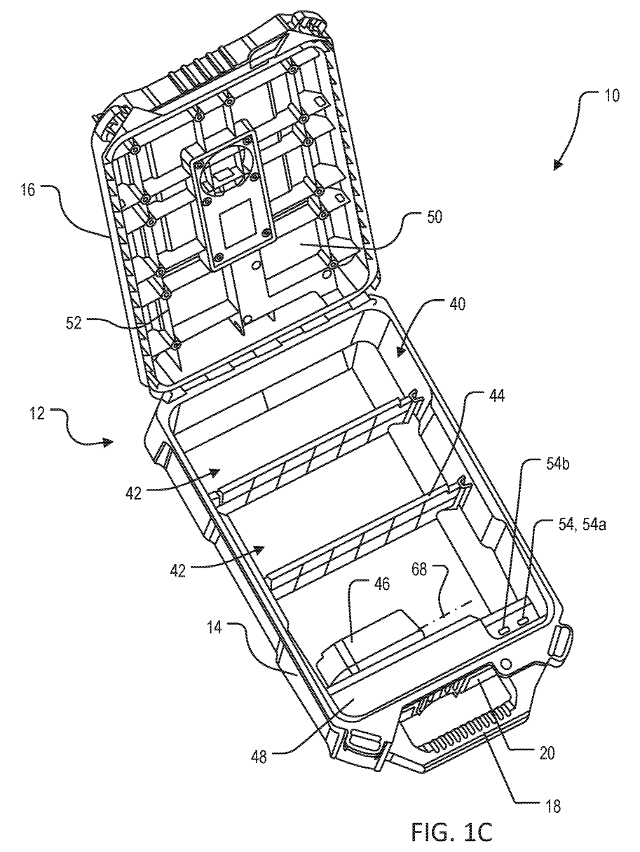

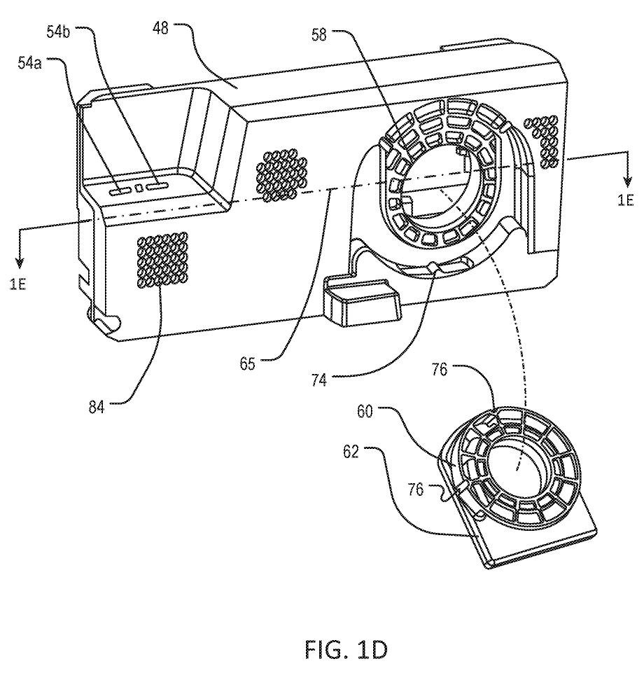

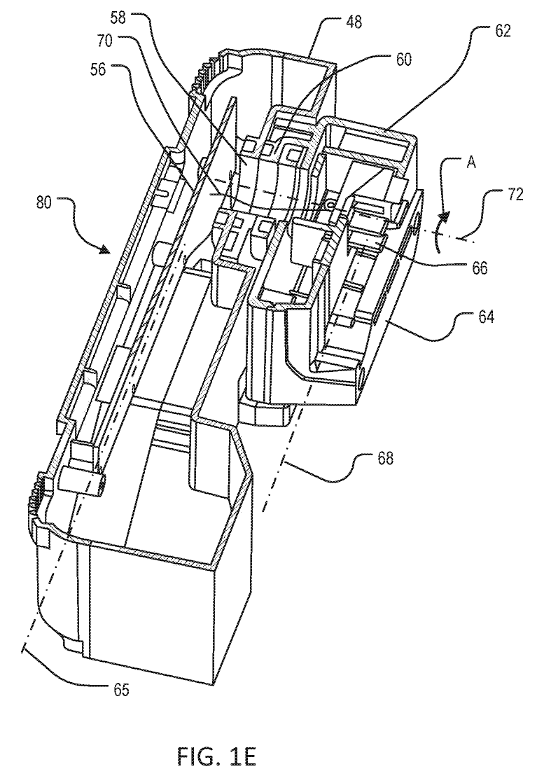

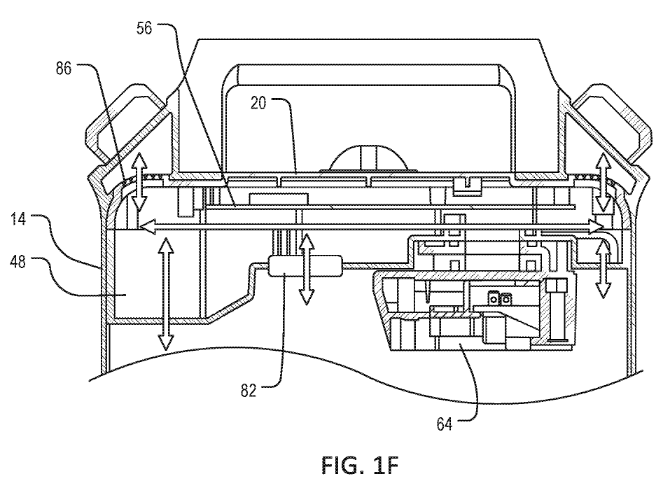

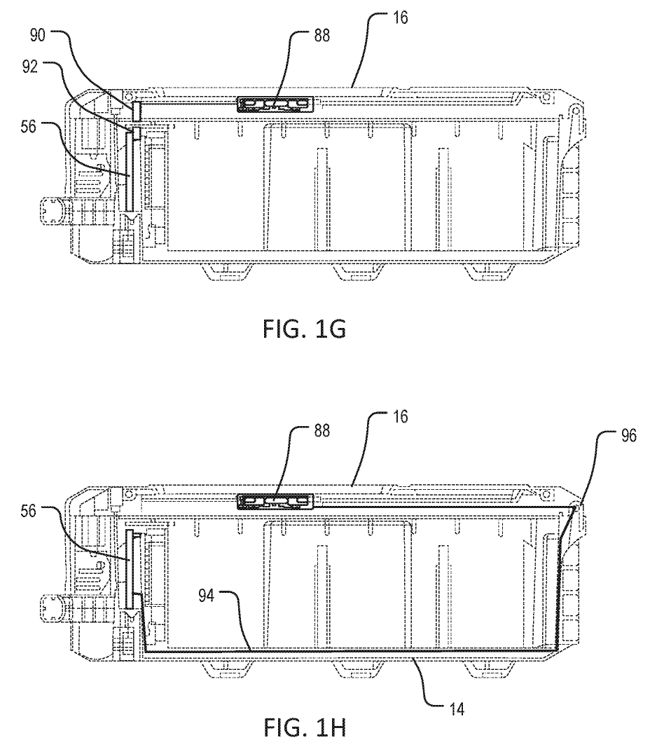

FIG. 1A illustrates a battery charger 10 according to an embodiment of the present disclosure. The illustrated charger 10 is configured as an organizer for personal device charging and storage. The charger 10 includes a generally rectangular housing 12 with a base 14 and a lid 16 pivotally coupled to the base 14. A handle 18 is fixed to and extends from a first end 20 of the base 14 for carrying the charger 10.

In the illustrated embodiment, a top or outer side 22 of the lid 16 includes a plurality of recesses 24, which may be standardized recesses configured to cooperate or interface with an accessory, such as a toolbox, parts organizer, or the like of the PACKOUT modular storage system sold by MILWAUKEE ELECTRIC TOOL CORPORATION, such that various PACKOUT accessories may be interchangeably coupled to the lid 16 and thus securely stacked on the charger 10. For example, each of the illustrated recesses 24 includes a bottom wall 26, a plurality of side walls 28 extending between the bottom wall 26 and the top side 22 of the lid, and a plurality of overhangs 30 that extend toward one another from a periphery of the recess 24 and that are spaced apart from the bottom wall 26 of the recess 24. The illustrated plurality of recesses 24 includes a plurality of first recesses 24a of a first size, and a second recess 24b of a second size larger than the first size.

As shown in FIG. 1B, a bottom side 32 of the base 14 includes a plurality of cleats 34 extending therefrom. The cleats 34 are configured to cooperate with recesses on a support structure, which may have the same geometries as the recesses 24 on the top side 22 of the lid 16. As such, the cleats 34 may likewise be configured to cooperate or interface with a toolbox, parts organizer, a wall plate, or the like of the PACKOUT modular storage system, thereby allowing the charger 10 to be interchangeably coupled to/securely stacked on a support structure of the modular storage system. In some embodiments, the charger 10 may be stacked on and removably coupled to a second charger 10 by aligning and inserting the cleats 34 of the charger 10 into the recesses 24 on the lid 16 of the second charger 10 and sliding the charger 10 until the cleats 34 are positioned underneath the overhangs 30.

Referring again to FIG. 1A, the illustrated base 14 includes an actuator 36 located at the first end 20 and having a projection 38 extending downwardly beyond the bottom side 32 of the base 14. The actuator 36 and the projection 38 are biased by a spring (not shown) into a locked position shown in FIG. 1A. A user may retract the projection 38 into the base 14 by manipulating the actuator 36. The projection 38 is configured to engage and disengage a corresponding recess on the support structure to releasably secure the charger 10 to the support structure. In other embodiments, the base 14 may include other engaging features, such as recesses, rails, or the like, configured to cooperate with corresponding engaging features on the support structure. Accordingly, the battery charger 10 may be securely mounted to the support structure (toolbox, wall plate, etc.) without the use of tools or fasteners.

Now referring to FIG. 1C, the interior of the housing 12 includes a main compartment 40, which may be divided into a plurality of sub-compartments 42 by one or more dividing walls 44. In some embodiments, the dividing walls 44 may be removably and/or repositionable by a user to vary the number and sizes of the sub-compartments 42. The main compartment 40 is configured to receive a battery 46 (e.g., a power tool battery pack) at an electronics housing 48 located proximate the first end 20 of the base 14. The battery 46 may include multiple battery cells having, for example, a lithium (Li), lithium-ion (Li-ion), or other lithium-based chemistry. For example, the battery cells may have a chemistry of lithium-cobalt (Li-Co), lithium-manganese (Li-Mn) spinel, or Li-Mn nickel. In such embodiments, each battery cell may have a nominal voltage of about, for example, 3.6V, 4.0V, or 4.2V. In other embodiments, the battery cells may have a nickel-cadmium, nickel-metal hydride, or lead acid battery chemistry. In further embodiments, the battery 46 may include fewer or more battery cells, and/or the battery cells may have a different nominal voltage. The battery 46 may be connectable to and operable to power various motorized power tools (e.g., a cut-off saw, a miter saw, a table saw, a core drill, an auger, a breaker, a demolition hammer, a compactor, a vibrator, a compressor, a drain cleaner, a welder, a cable tugger, a pump, etc.), outdoor tools (e.g., a chain saw, a string trimmer, a hedge trimmer, a blower, a lawn mower, etc.), other motorized devices (e.g., vehicles, utility carts, a material handling cart, etc.), and non-motorized electrical devices (e.g., a power supply, a light, an AC/DC adapter, a generator, etc.). In some embodiments, the battery 46 may be an M18 battery pack sold by MILWAUKEE ELECTRIC TOOL CORPORATION. In some embodiments, the battery 46 may have a nominal output voltage of about 18 Volts. In other embodiments, the battery 46 may be of another type and/or have a different nominal output voltage (e.g., 12 Volts, 24 Volts, 40 Volts, 80 Volts, etc.).

As described in greater detail below, the battery 46 may be charged while located within the main compartment 40 in some embodiments. Additionally or alternatively, the battery 46 may provide a source of power to charge or power one or more electronic devices, such as cellular phones, laptop computers, tablets, or the like. The electronic device(s) may be able to be stored within the main compartment 40 and optionally powered or charged within the main compartment 40 in some embodiments.

With continued reference to FIG. 1C, an inner side 50 of the lid 16 (which faces the interior of the housing 12 when the lid 16 is closed) includes one or more retainers 52 for securing the electronic device. The retainers 52 may include walls, tabs, posts, straps, or any other suitable means for retaining the electronic device on the inner side 50 of the lid 16, such that the electronic device may move with the lid 16 when the lid is opened.

The charger 10 includes one or more power ports 54, which may provide power to or from the battery 46 and power to or from the electronic device(s). In the illustrated embodiment, the charger includes three power ports 54a, 54b, 54c. More specifically, first and second power ports 54a, 54b are located on the electronics housing 48 inside of the main compartment 40 (FIG. 1C), and a third power port 54c is located at the first end 20 of the base 14 (and accessible from outside the main compartment 40; FIG. 1A). The power ports 54a, 54b, 54c may be USB ports in some embodiments, particularly USB-C ports. As described in greater detail below, the power ports 54a, 54b, 54c, together with electronics of the charger 10, advantageously provide the charger 10 with multiple power capabilities.

Referring to FIGS. 1D-1E, the electronics housing 48 is coupled to the base 14 and encloses a printed circuit board assembly (PCBA) 56 with electrical/electronic components, including but not limited to a controller (e.g., programmable microprocessor), non-transitory memory, and input/output interfaces that provide electrical connections, protection, monitoring, and operational control for the charger 10 to carry out the functions described herein. Each of the power ports 54a, 54b, 54c is electrically coupled to the PCBA 56 such that the PCBA 56 may regulate the voltage and current supplied to the respective power ports 54a, 54b, 54c.

The illustrated electronics housing 48 defines a longitudinal axis 65 and is elongated in a direction along the longitudinal axis 65. A circular aperture 58 extends through the electronics housing 48 and receives an annular boss 60 of a terminal mount 62 (FIG. 1D), such that the terminal mount 62 is rotatably coupled to the electronics housing 48. The terminal mount 62 supports a battery receptacle terminal block 64 (FIG. 1E), with blades 66 configured to interface with corresponding electrical contacts on the battery 46. The battery 46 may be slidably coupled to the terminal block 64 along a battery insertion/removal axis 68 to establish an electrical connection between the battery 46 and the terminal block 64. The terminal mount 62 (and thus, the terminal block 64) are rotatable about a battery rotation axis 72, as described in greater detail below, which is defined by and extends centrally through the annular boss 60 and the circular aperture 58. The terminal block 64 is electrically coupled to the PCBA 56 via one or more wires 70 extending through the center of the annular boss 60 and the circular aperture 58, which facilitates rotating the terminal block 64 without pulling on or damaging the wires 70.

In the illustrated embodiment, the battery insertion/removal axis 68 is perpendicular to the battery rotation axis 72. As such, the orientation of the battery insertion/removal axis 68 can be changed, depending on the rotational position of the terminal block 64. The illustrated terminal mount 62 and terminal block 64 are rotatable between a first position, shown in FIGS. 1E and 1C, in which the battery insertion/removal axis 68 is oriented parallel to the longitudinal axis 65 of the electronics housing 48, and a second position (not shown), in which the terminal mount 62 and terminal block 64 are rotated 90 degrees in the direction of arrow A, to thereby orient the battery insertion/removal axis 68 perpendicular to the longitudinal axis 65 of the electronics housing 48. In the second position, the battery insertion/removal axis 68 extends perpendicular to the bottom of the main compartment 40, allowing easier access to insert or remove the battery 46. Once the battery 46 is inserted, rotating the battery 46 together with the terminal block 64 and terminal mount 62 back to the first position, shown in FIG. 1C, allows for a more compact placement of the battery 46 and reduced overall height of the charger 10. This rotation feature may be particularly advantageous when the charger 10 is used with batteries such as the illustrated battery 46, which has its longest dimension along the insertion/removal axis 68.

Referring again to FIG. 1D, the electronics housing 48 supports a detent 74 configured to be received in and engage with notches 76 formed in an outer periphery of the annular boss 60 when the terminal mount 62 is in its first position and second position, respectively. The detent 74 may thus provide tactile and/or audible feedback to the user when the terminal mount 62 reaches the first position or the second position, and may provide resistance to retain the terminal mount 62 in the first position or the second position until sufficient force is applied by the user to rotate the battery 46. Thus, unintended rotation of the battery 46 may be prevented.

The electronics housing 48 also supports a user interface 80 in the illustrated embodiment, as shown in FIGS. 1A and 1E. The user interface may include one or more indicators (e.g., LED lights) with multiple colors to indicate, for example, a charge level of the battery 46, and a charge or discharge state for each of the power ports 54a, 54b, 54c.

Referring to FIGS. 1D and 1F, the charger 10 may include a fan 82 to cool the PCBA 56 and/or the battery 46 and electronic device(s) contained within the compartment 40. The fan 82 is located within the electronics housing 48 in the illustrated embodiment, and communicates with the interior of the compartment through inner vent openings 84 (FIG. 1D) and with the outside environment through outer vent openings 86 (FIG. 1E). In some embodiments, the fan 82 may be configured to draw outside air in through the outer vent openings 86, over the PCBA 56, and then into the compartment 40 through the inner vent openings 84. In other embodiments, the fan 82 may be configured to exhaust air from the compartment 40 over the PCBA 56 and out through the outer vent openings 86.

Referring to FIGS. 1G and 1H, in some embodiments, the charger 10 further includes a wireless charger pad 88 located on the lid 16. The wireless charger pad 88 is configured to provide power to a compatible electronic device wirelessly when the electronic device is placed on or in close proximity to the wireless charger pad 88. The wireless charger pad 88 may be, for example, a Qi, Qi2 or similar wireless charger and may include magnetic alignment features in some embodiments. As shown in FIG. 1G, the wireless charger pad 88 may be electrically coupled to the PCBA 56 via pogo pins 90, 92 that engage when the lid 16 is closed, and that disengage when the lid 16 is opened. In another embodiment, as shown in FIG. 1H, a wire 94 may electrically connect the wireless charger pad 88 to the PCBA 56. The wire 94 may be routed along the bottom of the base 14 (in a wire track within the compartment 40, for example), or embedded within the base 14, and then routed through a hinge 96 that couples the base 14 to the lid 16.

Referring to FIG. 1A, the illustrated wireless charger pad 88 is located within the second recess 24b and projects from the bottom wall 26 of the second recess 24b. This allows a compatible electronic device to be placed on the wireless charger pad 88 to charge, while the electronic device remains below the top side 22 of the lid 16. As such, the electronic device may be protected, and additional toolboxes, organizers, accessories, etc. of the modular tool storage system may be coupled to the lid 16 even while the electronic device is charging on the wireless charger pad 88.

In use, the first and second power ports 54a, 54b are configured to provide power output to power or charge connected electronic device(s). The compartment 40 thus allows for charging, protection, and secure storage of electronic devices while in transit or on the job. In some embodiments, the first and second power ports 54a, 54b may each have a rated output of 15W. In other embodiments, the first and second power ports 54a, 54b may have different outputs. The compartment 40 may include ingress protection, shielding stored devices, batteries, etc. from dust, debris, and water exposure in various job side conditions. In some embodiments, the compartment 40 of the charger 10 is configured to meet or exceed IEC Ingress Protection Standard 54 (IP54).

Referring again to FIG. 1A, the third power port 54c in the illustrated embodiment is a bi-directional charging and output port, such as a USB-C port. The third power port 54c may have a higher power rating than the first and second power ports 54a, 54b. For example, the third power port 54c may have a power rating of at least 100W in some embodiments. The third power port 54c may be connected to a source of power (e.g., a 100W DC power source) and provide power to the battery 46 to charge the battery 46. Power input to the third power port 54c may additionally or alternatively power the first and second power ports 54a, 54b and/or the wireless charger pad 88 to provide power to connected electronic device(s). In some embodiments, power input to the third power port 54c may simultaneously charge or power the battery 46 and electronic devices connected to each of the first and second power ports 54a, 54b and/or the wireless charger pad 88. In some embodiments, power input to the third power port 54c may power electronic devices connected to each of the first and second power ports 54a, 54b and/or the wireless charger pad 88 even when the battery 46 is removed.

Because the third power port 54c is bi-directional in the illustrated embodiment, power from the battery 46 may also be output through the third power port 54c. For example, the battery 46 may supply up to 100W of power through the third power port 54c to a connected electronic device, enabling the charger 10 to support higher power electronic devices or to charge the connected electronic device more quickly than via the lower power first and second power ports 54a, 54b. Thus, the charger 10 provides multiple power capabilities, including charging the battery 46 from an external source of power, charging or powering one or more electronic devices from an external source of power (either simultaneously with or independently from charging the battery 46), and charging or powering one or more electronic devices using the battery 46, all within a convenient, modular, and rugged package that is easy to transport and to integrate into a modular tool storage system. Furthermore, because all of the power ports 54 are USB-C ports in the illustrated embodiment, a user may advantageously use existing or readily available cables to connect to the charger 10.

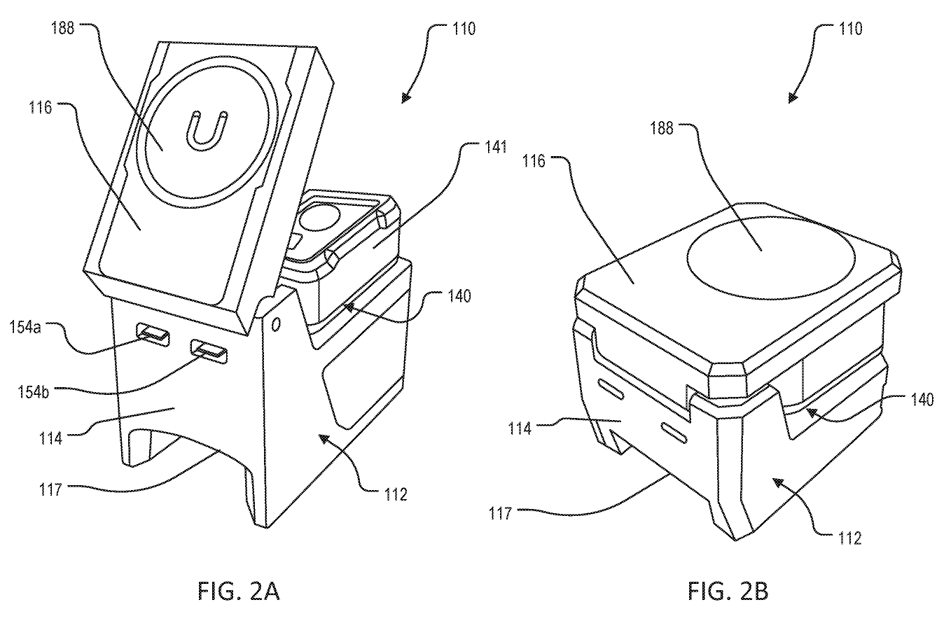

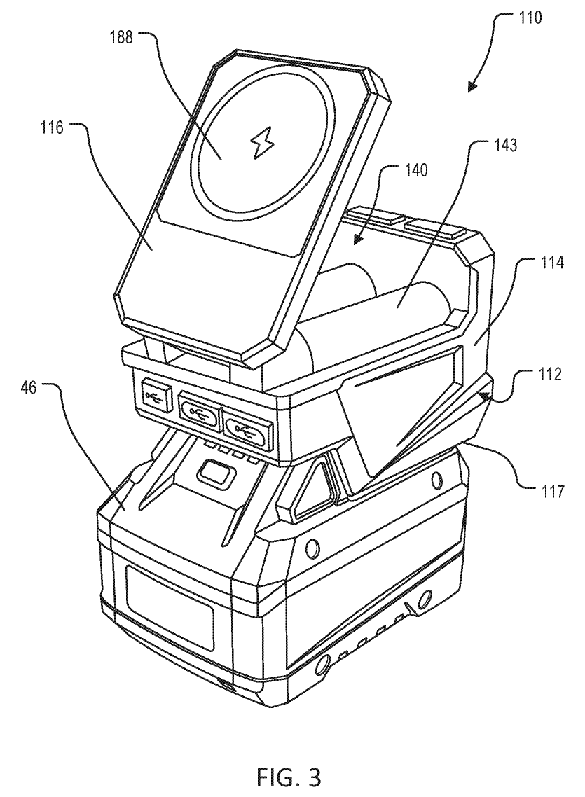

FIGS. 2A-3 illustrate a battery charger 110 according to another embodiment. The illustrated battery charger 110 includes a housing 112 with a base 114 and a lid 116 pivotally coupled to the base 114. The base 114 includes a receptacle 117 configured to receive and couple to a battery, such as the battery 46.

The illustrated charger 110 includes a compartment 140 between the base 114 and the lid 116, which may receive an electronic device, such as a headlamp 141 (FIG. 2A). Power ports 154a, 154b (e.g., USB-C ports) are provided on the base 114, and a wireless charger pad 188 is provided on the lid 116. In some embodiments, the compartment 140 provides an additional charging area to receive and charge the headlamp 141, secondary batteries 143, or other compatible electronic devices. In the embodiment of FIG. 3, the compartment 140 includes two receptacles (e.g., battery bays) for charging secondary batteries 143 (e.g., Milwaukee Tool RedLithium USB batteries).

The lid 116 is pivotable relative to the base 114 between a first position (FIG. 2B), where the lid 116 closes the compartment 140, and a second position (FIGS. 2A, 3), where the lid pivots away from the base 114, exposing the compartment 140. The charger 110 thus provides convenient storage, protection, and charging for the electronic device(s) within the compartment 140. One or both of power ports 154a, 154b may be bi-directional power ports to permit charging of the battery 46 and simultaneous charging of the electronic device(s). The power ports 154a,154b may also output power from the battery 46 to a connected electronic device, to the electronic devices within the compartment 140, and/or an electronic device on the wireless charger pad 188.

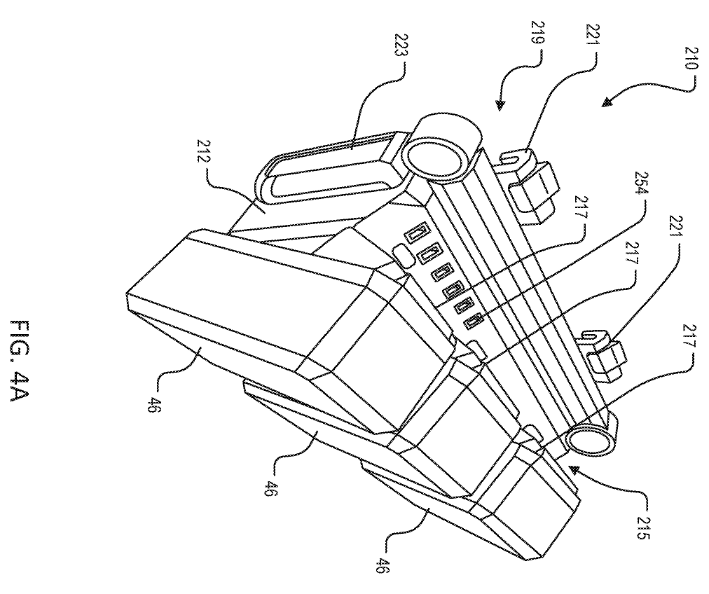

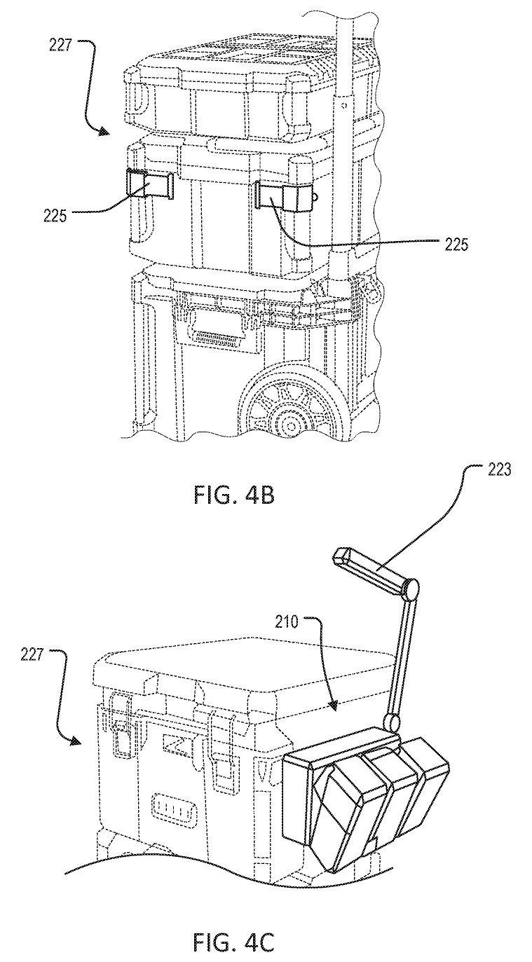

FIG. 4A illustrates a battery charger 210 according to another embodiment. The illustrated charger 210 includes a generally rectangular housing 212 with a first side 215 having multiple battery interfaces 217, and a second side 219 having mounting hooks 221. The housing 212 additionally supports a work light 223 pivotable between a first, stored, position (FIG. 4A) and a second, extended position (FIG. 4C). When in the second position, the work light 223 is operable to emit light to the surrounding area, providing illumination for dim workspaces.

The battery interfaces 217 are configured to receive power tool battery packs, such as the battery 46. In the illustrated embodiments, the housing 212 includes three battery interfaces 217. However, additional or fewer battery interfaces 217 may be included. The mounting hooks 221 are configured to interface with brackets 225 coupled to a toolbox, a wall plate, or the like of the PACKOUT modular storage system 227 (FIG. 4B).

The charger 210 may include one or more bi-directional power ports 254, such as a USB-C port, to charge the connected battery packs 46 or to charge a connected electronic device (e.g., from the battery packs 46). The work light 223 may be powered directly by the connected battery packs 46 or may be powered from an external power source via the power port 254.

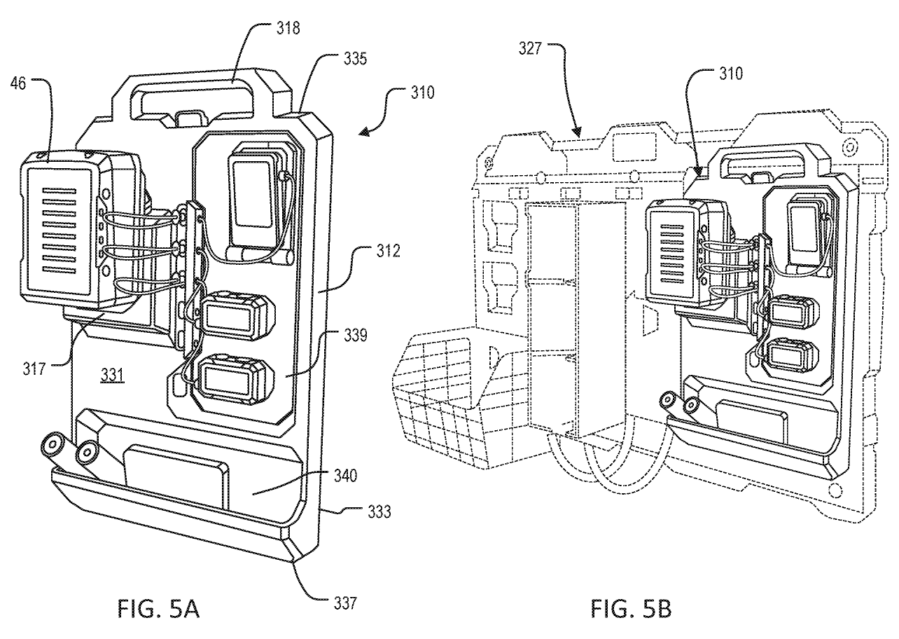

FIGS. 5A-5B illustrate a charger 310 according to another embodiment. More particularly, the illustrated charger 310 is a wall mount for personal device charging and storage. The charger 310 includes a generally flat, rectangular housing 312 having a first face 331, a second face 333 opposite the first face 331, an upper end 335, and a bottom end 337 opposite the upper end 335. A handle 318 extends from the upper end 335 for carrying the charger 310.

The first face 331 supports a battery interface 317 configured to receive a power tool battery pack, such as the battery 46. The first face 331 additionally supports a plate 339 composed of magnetic material. The plate 339 allows magnetic products to be magnetically affixed to the charger 310 (e.g., headlamps, portable lights, etc.) and charged via a wired or wireless connection. A storage compartment, or recess 340, is positioned in the first face 331. The recess 340 is shaped and sized to hold small items (e.g., batteries, electronic devices, etc.). The second face 333 supports a mounting system (e.g., cleats, such as cleats 34) that interfaces with a toolbox, a wall plate, or the like of the PACKOUT modular storage system 327, as shown in FIG. 5B.

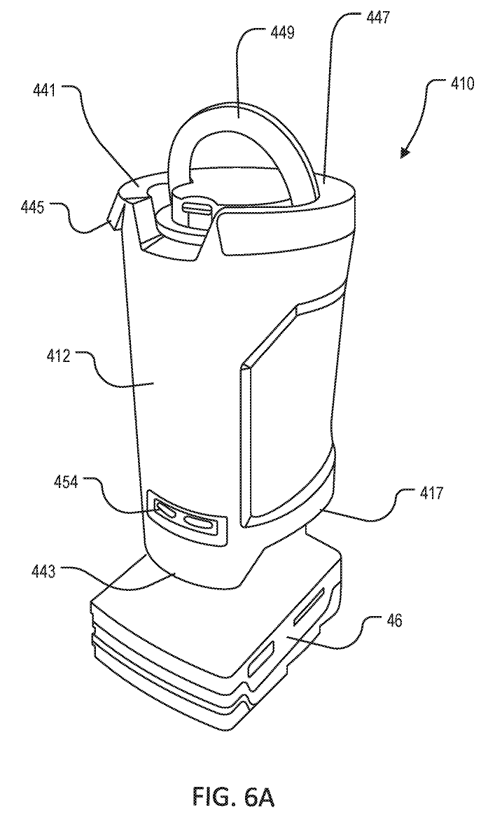

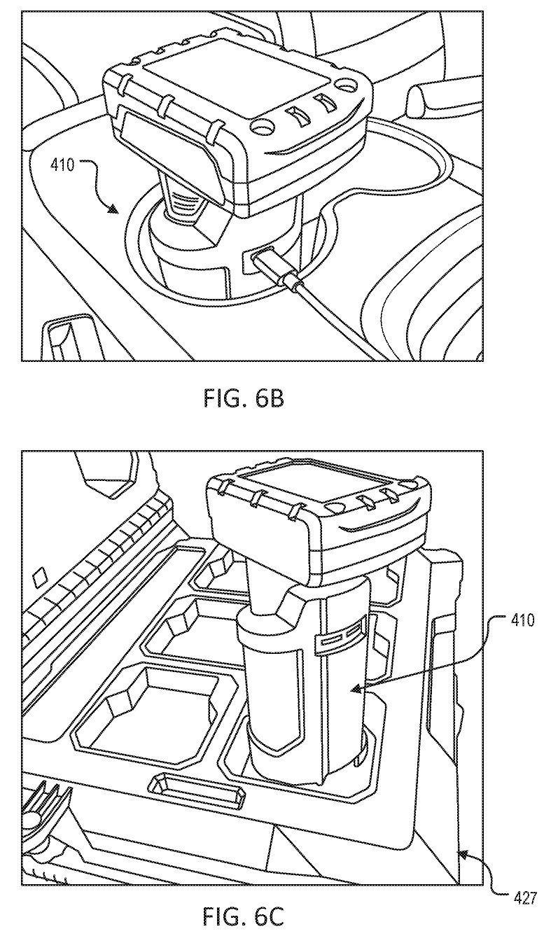

FIGS. 6A-6C illustrate a charger 410 according to another embodiment. The illustrated charger 410 is shaped and sized to fit within a variety of cupholders (FIG. 6B) and mounting systems (FIG. 6C). The charger 410 includes a housing 412 having a first end 441, and a second end 443 opposite the first end 441. The housing 412 is generally cylindrical and is shaped and sized to fit within a cupholder (FIG. 6B). The first end 441 includes a mounting system 445 that interfaces with a toolbox, a wall plate, or the like of the PACKOUT modular storage system 427 (FIG. 6C). More specifically, the illustrated mounting system 445 is a twist cleat, allowing the charger 410 to be locked in a corresponding mounting recess (such as the recesses 24). However, alternative types of mounting mechanisms may be used.

A lid 447 is removably coupled to the first end 441 of the housing 412. The lid 447 includes a hook 449 pivotable between a first, stored, position, and a second, extended position (shown in FIG. 6A). The hook 449 may be used to hang the charger 410 on various objects (e.g., carabiner, backpack, fastener, etc.), or as a handle to transport the charger 410.

The second end 443 of the housing includes a battery interface 417 configured to receive a power tool battery pack, such as the battery 46, an M12 battery pack, or the like. The housing includes one or more bi-directional power ports 454, such as a USB-C bi-directional power port, operable to charge an electronic device (e.g., cellphone, tablet, etc.) or to receive power from an external power source to charge the battery 46 and/or a connected electronic device. Additional charging output ports or different types of power interfaces may also be included.

Various features and aspects of the present disclosure are set forth in the following claims.

1. A battery charger comprising:
a housing including a base and a lid pivotally coupled to the base, the base and the lid cooperating to define a compartment when the lid is in a closed position;
a battery receptacle coupled to the housing and configured to receive a battery; and
a bi-directional power port,
wherein the battery charger is operable in a first mode in which the bi-directional power port is electrically coupled to an external power source and a second mode in which the bi-directional power port is electrically coupled to an electronic device,
wherein the battery charger is configured to charge the battery in the first mode, and
wherein the battery charger is configured to provide power from the battery to the electronic device in the second mode.

2. The battery charger of claim 1, further comprising a wireless charging pad coupled to the housing.

3. The battery charger of claim 2, wherein the wireless charging pad is located on the lid.

4. The battery charger of claim 2, wherein the battery charger is operable in a third mode in which the electronic device is positioned proximate the wireless charging pad, and wherein the battery charger is configured to provide power from the battery to the electronic device via the wireless charging pad in the third mode.

5. The battery charger of claim 1, wherein the battery receptacle is located inside the compartment.

6. The battery charger of claim 5, wherein the battery is configured to be coupled to and removed from the battery receptacle along a battery insertion axis, and wherein the battery receptacle is rotatable to vary an orientation of the battery insertion axis relative to the housing.

7. The battery charger of claim 6, wherein the housing includes an electronics housing coupled to the base, the electronics housing enclosing a PCBA electrically coupled to the battery receptacle and the bi-directional power port.

8. The battery charger of claim 7, wherein the battery receptacle includes a terminal mount rotatably coupled to the electronics housing.

9. The battery charger of claim 8, wherein the electronics housing includes a circular aperture, and wherein the terminal mount includes an annular boss received in the circular aperture.

10. The battery charger of claim 1, wherein the bi-directional power port is a first power port, and wherein the battery charger further includes a second power port located inside the compartment.

11. The battery charger of claim 10, wherein the first power port is located outside the compartment such that the first power port is accessible from an exterior of the housing.

12. The battery charger of claim 1, wherein the lid includes a plurality of recesses, and the base includes a plurality of cleats.

13. The battery charger of claim 1, wherein the first power port is a USB-C port.

14. A battery charger comprising:
a housing including a base and a lid pivotally coupled to the base, the base and the lid cooperating to define a compartment configured to receive and store an electronic device when the lid is in a closed position;
a battery receptacle coupled to the housing inside the compartment and configured to receive a battery such that the battery is positionable inside the compartment;
a power port located inside the compartment, the power port configured to be electrically coupled to an electronic device to provide power from the battery to the electronic device while the electronic device is located within the compartment.

15. The battery charger of claim 14, wherein the base includes a plurality of cleats and the lid includes a plurality of recesses such that the battery charger is configured to be coupled to a modular tool storage system without the use of tools.

16. The battery charger of claim 14, wherein the housing includes an electronics housing coupled to the base, the electronics housing enclosing a PCBA electrically coupled to the battery receptacle and the power port.

17. The battery charger of claim 16, further comprising a fan within the electronics housing to cool the PCBA.

18. The battery charger of claim 16, wherein the battery receptacle is rotatably coupled to the electronics housing.

19. The battery charger of claim 1, further comprising a wireless charging
pad located on the lid.

20. A battery charger comprising:
a housing including a base and a lid, the base and the lid cooperating to define a compartment within the housing, the base including a plurality of cleats and the lid including a plurality of recesses;
a battery receptacle coupled to the housing inside the compartment and configured to receive a battery such that the battery is positionable inside the compartment;
a bi-directional power port configured to connect to an external power source to provide power to the battery and configured to connect to an electronic device to provide power from the battery to the electronic device.
